(19) United States
(12) Patent Application Publication
(10) Pub. No.: US 2026/0198410 A1
(43) Pub. Date: Jul. 16, 2026

(54) HARVESTING DEVICE

(71) Applicant: POPPE GROUP B.V., Meliskerke (NL)

(72) Inventors: Bertus Johannes POPPE, Meliskerke (NL); Bertus Marinus POPPE, Meliskerke (NL); Marinus Willem POPPE, Meliskerke (NL)

(73) Assignee: POPPE GROUP B.V., Meliskerke (NL)

(21) Appl. No.: 19/133,564

(22) PCT Filed: Dec. 4, 2023
(86) PCT No.: PCT/NL2023/050636

§ 371 Date: May 28, 2025

(30) Foreign Application Priority Data
Dec. 6, 2022 (NL) 2033677

(51) Int. Cl. A01D 25/04; A01B 61/04

(52) U.S. Cl. CPC A01D 25/044; A01B 61/046

(57) ABSTRACT

Harvesting device configured to be mounted on a root crop harvester that is movable in a travel direction for progressively harvesting root crop in soil along the travel direction, wherein the harvesting device comprises a mounting frame for mounting the harvesting device on the root crop harvester, and a pair of dished disc-shaped shares for cutting into the soil and transporting root crop from said soil towards a processing region, wherein the disc-shaped shares are rotatably mounted side-by-side to the mounting frame, and the disc-shaped shares are rotatable about their respective centre axes in mutually opposite directions such that, during rotation, root crops are collected by the disc-shaped shares in a transportation region and moved towards the processing region, wherein an edge region of one of the disc-shaped shares overlaps an edge region of the other disc-shaped share in the transportation region.

The present invention relates to a harvesting device configured to be mounted on a root crop harvester that is movable in a travel direction for progressively harvesting root crop in soil along the travel direction. The present invention further relates to a root crop harvester provided with such a harvesting device, a method of harvesting root crop in soil using the root crop harvester, and a method of adapting a root crop harvester.

Root crops, such as potatoes and other types of tuber crop as well as bulb crops such as onions, can be harvested by harvesting devices that are, e.g., mounted to tractors or root crop harvesters. Where the harvesting device meets the potatoes in the soil, the harvesting device has a blade known as a share, usually at the front of the harvester. The harvesting device harvests the potatoes by lifting the potatoes from a soil bed or ridge using the share. As the harvester progresses, soil material and potatoes move over the share and are transferred onto a moving belt known as a web, or a series of webs, where the potatoes are finally separated from the soil materials. A potato harvester can cover multiple rows of potatoes at once and operates using a diablo roller for each row of potatoes or a cone-shaped roller acting as depth control. The rollers cover the rows of potatoes whilst the shares dig underneath the potatoes and the soil, lifting them onto the web.

Such a harvesting device is known from UK patent publications Nos. GB 1 601 478, GB 2 118 812 and GB 2 119 216, and comprises a mounting frame for mounting the harvesting device on the root crop harvester, and a pair of dished disc-shaped shares for cutting into the soil and transporting root crop from said soil towards a processing region. Each disc-shaped share has a leading edge arranged to cut into the soil and a trailing edge opposite to the leading edge. The disc-shaped shares are rotatably mounted side-by-side to the mounting frame and the disc-shaped shares are rotatable about their respective centre axes in mutually opposite directions such that, during rotation, root crops are collected by the disc-shaped shares in a transportation region and moved towards the processing region. That is, upon collecting the root crops, the rotating disc-shaped shares transport the root crops through the region between the centres of the disc-shaped shares, herein referred to as the transportation region, towards a region where the root crops are to be deposited, for instance for further treatment, herein referred to as the processing region.

The root crop harvester draws the disc-shaped shares along, for instance, a ridge in which potatoes are growing, to progressively collect the material of the ridge and deposit the material including the potatoes on a conveyor of the root crop harvester. The conveyor conveys the material of the ridge for further treatment on the harvester, particularly further separation of the potatoes from the soil material. The conveyor is usually an endless belt or web with a material-receiving portion for receiving the root crop from the shares.

The disc-shaped shares can be adjusted relative to the ground by displacement of the frame member to which the shares are mounted, particularly for harvesting on a downhill or an uphill slope.

A first drawback of the known device is that much of the root crop is not collected or falls off the disc-shaped shares during transportation towards the processing region. As a result, a significant loss of root crop through spillage can occur.

A second drawback is that the disc-shaped shares are easily damaged by rocks in the soil. To increase the durability of the disc-shaped shares, the components of the harvesting device are strengthened by adding material or using stronger material, resulting in a bulky and/or costly harvesting device.

A third drawback is that, to adjust the disc-shaped shares relative to the ground for adaptation to a slope, two distinct adjustment steps are required to ensure that the gap between the trailing end of the shares and the material-receiving portion of the conveyor allows the shares to deposit the root crop on the conveyor.

It is therefore an object of the present invention, amongst other objects, to at least partially alleviate the aforenoted drawbacks.

Hereto, according to a first aspect, a harvesting device is provided that is configured to be mounted on a root crop harvester that is movable in a travel direction for progressively harvesting root crop in soil along the travel direction, wherein the harvesting device comprises a mounting frame for mounting the harvesting device on the root crop harvester, and a pair of dished disc-shaped shares for cutting into the soil and transporting root crop from said soil towards a processing region, wherein the disc-shaped shares are rotatably mounted side-by-side to the mounting frame, and the disc-shaped shares are rotatable about their respective centre axes in mutually opposite directions such that, during rotation, root crops are collected by the disc-shaped shares in a transportation region and moved towards the processing region, wherein an edge region of one of the disc-shaped shares overlaps an edge region of the other disc-shaped share in the transportation region.

The disc-shaped shares are mounted side-by-side as seen in mutually perpendicular axial and frontal planes of the harvesting device and are arranged on either side of a lateral plane of the harvesting device perpendicular to the (horizontal) axial and the (vertical) frontal plane. The frontal plane is perpendicular to a working direction of the harvesting device which corresponds to the travel direction of the root crop harvester. The edge region of the one disc-shaped share overlaps the edge region of the other disc-shaped share as seen in the axial plane, i.e., when viewed in plan. The term “overlapping” is defined as covering a part by extending thereover. The one edge region overlapping the other edge region is thus to be understood as the one edge region extending over the other edge region and thereby covering part thereof when viewed from above.

As the disc-shaped shares partially overlap, in the transportation region, more root crop can be collected, particularly between the centre axes of the disc-shaped shares, and the loss of root crop can be reduced since, for example, root crop falling off the one disc-shaped share can be collected by the other disc-shaped share.

As the harvesting device can be suitably mounted on a root crop harvester via its mounting frame, the harvesting device may form part of a conversion or adaptation kit for adapting a root crop harvester to, e.g., a two-row twin-disc root crop harvester provided with the harvesting device according to the invention. Preferably, the harvesting device, or at least components thereof, can be disassembled from the root crop harvester for servicing or replacement.

Preferably, each dished disc-shaped share has a convex lower surface. It is further preferred if each dished disc-shaped share is tilted rearwardly upwards, i.e., relative to the axial plane or the travel direction of the root crop harvester, for instance at a rearward tilt angle in the range of 20 to 25 degrees, as seen in the lateral plane. That is, the centre axes of the disc-shaped shares incline upwardly and forwardly, for instance at an angle in the range of 20 to 25 degrees relative to the frontal plane, when viewed in the lateral plane. As such, the disc-shaped shares are rotatably mounted side-by-side to the mounting frame, and the disc-shaped shares are rotatable about their respective centre axes in mutually opposite directions such that, during rotation, respective edges of the disc-shaped shares move rearwardly upwards where the disc-shaped shares meet. The disc-shaped shares preferably have corresponding or equal radii.

The dished, tilted share may scoop the soil and an increasing build-up of soil material on the disc-shaped share may bury the share into the soil. Therefore, according to a preferred embodiment of the harvesting device, at least one of the disc-shaped shares comprises a flange along its edge region, wherein the flange extends in the transportation region. That is, the dished disc-shaped share comprises a dished centre and a flange extending radially outwards therefrom. Preferably, each flange has a width of at least 10 percent of a radius of the disc-shaped shares.

The flange enhances the overlapping of the disc-shaped shares. Moreover, as the disc-shaped share is tilted, the flange ensures a clearance between the outermost region of the dished centre of the share and the leading edge of the share which is located on the outermost edge of the flange and cuts into the soil. This clearance reduces the friction between the disc-shaped share and the soil.

Preferably, each of the disc-shaped shares comprises a flange along its respective edge region, wherein the flange of the one disc-shaped share overlaps the flange of the other disc-shaped share in the transportation region. It is then further preferred if the flanges extend mutually parallel in the transportation region. This further enhances the overlapping of the disc-shaped shares, as the space between the respective flanges in the transportation region can be reduced, which reduces the crop loss.

The disc-shaped shares are preferably arranged at equal height. To prevent the overlapping shares at equal height from colliding with one another, according to a further preferred embodiment of the harvesting device, the disc-shaped shares are laterally tilted outwardly upwards, i.e., relative to the axial plane, for instance at a lateral tilt angle in the range of 5 to 20 degrees, as seen in the frontal plane. Preferably, the lateral tilt angle is 20 degrees or less, preferably 15 degrees or less, more preferably 10 degrees or less. As such, the dished disc-shaped shares are mutually convergent, wherein the centre axes slope upwardly and inwardly, for instance at an angle in the range of 5 to 20 degrees relative to the lateral plane, when viewed in the frontal plane. Preferably, the disc-shaped shares are laterally tilted at slightly different angles. This further allows the disc-shaped shares arranged at equal height to overlap.

To allow the flanges of the laterally tilted disc-shaped shares to extend mutually parallel in the transportation region, the flange is preferably frustoconical. Specifically, the flange lies in a frustoconical plane that is coaxial with the disc-shaped share. The frustoconical plane converges in the direction of convexity of the dished disc-shaped share, i.e., towards the centre of the share.

According to a further preferred embodiment of the harvesting device, the transportation region has an overlap length in the travel direction, wherein the overlap length is at least 50 percent of a radius of the disc-shaped shares. The overlap length may thus be more than 50 percent of the radius, preferably at least 50 percent of a diameter of the disc-shaped shares. As noted above, the travel direction of the root crop harvester corresponds to the working direction of the harvesting device.

According to a second aspect, a harvesting device is provided, preferably according to any of the above embodiments, wherein the harvesting device is configured to be mounted on a root crop harvester that is movable in a travel direction for progressively harvesting root crop in soil along the travel direction, wherein the harvesting device comprises a mounting frame for mounting the harvesting device on the root crop harvester, and at least one disc-shaped share for cutting into the soil and transporting root crop from said soil towards a processing region, wherein the disc-shaped share is rotatably mounted to the mounting frame. Preferably, the harvesting device further comprises a share protection mechanism configured for displacing the at least one disc-shaped share from a cutting position, in which the disc-shaped share is arranged to cut into the soil, upwards to a protected position, in which the disc-shaped share is arranged out of the soil, upon collision of the disc-shaped share with a hard object in the soil.

The share protection mechanism can prevent damage to the at least one disc-shaped share by rocks in the soil. By displacing the disc-shaped share out of the soil, the durability of the disc-shaped share can be increased in a cost-efficient manner while maintaining a compact harvesting device.

The share protection mechanism may be configured for translating the at least one disc-shaped share from the cutting position to the protected position, for instance in a straight line.

However, according to a preferred embodiment of the harvesting device, the share protection mechanism is configured for pivoting the at least one disc-shaped share from the cutting position to the protected position about a hinge axis. This way, the at least one disc-shaped share can be efficiently pivoted out of the soil. Preferably, the hinge axis is parallel to a leading vertical plane tangent to a leading edge of the at least one disc-shaped share in the cutting position. The hinge axis then preferably extends above the leading edge in the cutting position and is located within or, as seen along the travel direction, ahead of said leading vertical plane. This ensures that the leading edge of the disc-shaped share moves either directly upwards or rearwards and subsequently upwards, i.e., without first moving downwards deeper into the soil. This way, it can be ensured that the disc-shaped share is able to move out of the soil and further damage can be prevented.

The leading edge can be defined as the side of the rotating disc-shaped share cutting into the soil. As such, the leading vertical plane may be parallel to, or coplanar with, the frontal plane of the harvesting device, or perpendicular to the travel and working direction. The hinge axis extending above the leading edge extends, more specifically, at a location higher than the leading edge. If the hinge axis is located ahead of the leading vertical plane as seen along the travel direction, the hinge axis is located on a side of the leading vertical plane away from the centre of the disc-shaped share. The hinge axis is preferably horizontal, i.e., parallel to the axial plane of the harvesting device.

Although the leading vertical plane may be parallel to the frontal plane, according to an alternative embodiment the hinge axis may extend at an acute angle with the frontal plane, such that the share protection mechanism is configured for pivoting the at least one disc-shaped share upwards in a direction with a lateral component. In the case of a pair of disc-shaped shares, the disc-shaped shares can thus be pivoted upwards away from one another about respective hinge axes.

Preferably, the share protection mechanism comprises at least one hinge which pivotably connects the at least one disc-shaped share to the mounting frame, wherein the hinge is arranged for pivoting the at least one disc-shaped share from the cutting position to the protected position about the hinge axis.

According to a further preferred embodiment of the harvesting device, the share protection mechanism comprises a biasing mechanism arranged to bias the at least one disc-shaped share to the cutting position. This way, it can be prevented that the disc-shaped share already swings to the protected position upon encountering minimal resistance. As such, it can be ensured that the disc-shaped share only moves to the protected position upon collision with a hard object in the soil. The biasing mechanism can be configured to exert a biasing force that can be predefined and selectively adjusted. Preferably, the biasing mechanism comprises the hinge, wherein the hinge is a spring-loaded hinge.

According to a further preferred embodiment of the harvesting device, the harvesting device comprises a pair of the disc-shaped shares, wherein the disc-shaped shares are separately movable from the cutting position to the protected position. Advantageously, one of the shares can remain in the cutting position and continue harvesting when the other share is swung to the protected position.

According to a third aspect, a harvesting device is provided, preferably according to any of the above embodiments, wherein the harvesting device is configured to be mounted on a root crop harvester that is movable in a travel direction for progressively harvesting root crop in soil along the travel direction, wherein the harvesting device comprises a mounting frame for mounting the harvesting device on the root crop harvester, and at least one disc-shaped share for cutting into the soil and transporting root crop from said soil towards a processing region, wherein the disc-shaped share is rotatably mounted to the mounting frame, wherein each disc-shaped share is tilted rearwardly upwards at a rearward tilt angle, wherein the harvesting device further comprises an adjustment mechanism for adjusting the rearward tilt angle relative to the frame, wherein the adjustment mechanism is configured for pivoting each disc-shaped share about a pivot axis parallel to a centre vertical plane extending through a centre of the disc-shaped share, wherein the pivot axis extends, as seen along the travel direction, trailing said centre vertical plane.

That is, the pivot axis for adjusting the disc-shaped share relative to the ground for adaptation to a slope is positioned at a location trailing the centre of the disc-shaped share. By positioning the pivot axis in the rear, the rearward tilt angle can be adjusted relative to the mounting frame in a single adjustment step while ensuring that the at least one share can still deposit the collected root crop in the processing region, for instance on a conveyor of the root crop harvester.

The centre vertical plane may be parallel to, or coplanar with, the frontal plane of the harvesting device. The pivot axis extending trailing the centre vertical plane as seen along the travel direction extends, more specifically, on a side of the centre vertical plane away from the leading edge of the disc-shaped share cutting into the soil. The pivot axis is preferably horizontal, i.e., parallel to the axial plane of the harvesting device.

For example, the mounting frame may comprise a first frame member and a second frame member, wherein the first frame member is configured to be mounted to the root crop harvester and the at least one disc-shaped share is mounted to the second frame member. The second frame member is pivotably connected to the first frame member, wherein the adjustment mechanism is configured for pivoting the second frame member relative to the first frame member about the pivot axis. For instance, the adjustment mechanism comprises a peg and slot adjuster provided in the first frame member and the second frame member.

According to a preferred embodiment of the harvesting device, the pivot axis extends below a trailing edge of the at least one disc-shaped share. The trailing edge can be defined as the side of the rotating disc-shaped share opposite the leading edge cutting into the soil. The pivot axis extending below the trailing edge extends, more specifically, at a location lower than the trailing edge. It is preferred if the pivot axis is substantially horizontal and extends, substantially, directly below the trailing edge of the disc-shaped share.

According to a further preferred embodiment of the harvesting device, the pivot axis extends through the processing region. This way, it can be further ensured that the rearward tilt angle can be adjusted relative to the mounting frame in a single adjustment step while ensuring that the at least one share can still deposit the collected root crop in the processing region.

Preferably, the harvesting device comprises the adjustment mechanism for pivoting each disc-shaped share about the pivot axis and, distinct therefrom, the above-described share protection mechanism for pivoting the disc-shaped share from the cutting position to the protected position about the hinge axis that is spaced from the pivot axis.

According to a fourth aspect, a harvesting device is provided that is configured to be mounted on a root crop harvester that is movable in a travel direction for progressively harvesting root crop in soil along the travel direction, wherein the harvesting device comprises a mounting frame for mounting the harvesting device on the root crop harvester, and a pair of disc-shaped shares for cutting into the soil and transporting root crop from said soil towards a processing region, wherein the disc-shaped shares are rotatably mounted side-by-side to the mounting frame, and the disc-shaped shares are rotatable about their respective centre axes in mutually opposite directions such that, during rotation, root crops are collected by the disc-shaped shares in a transportation region and moved towards the processing region, wherein the harvesting device further comprises a coupling member arranged to rotationally couple the disc-shaped shares. That is, the coupling member couples the rotation of the disc-shaped shares.

The root crop harvester, or the harvesting device, may comprise a hydraulic drive for rotationally driving the pair of disc-shaped shares. The hydraulic drive may be supplied with hydraulic fluid from a pump arranged on the frame of the root crop harvester. Considering inter alia the cost of the pump, it is preferred to employ a single pump for the pair of disc-shaped shares. Conventionally, to rotationally drive the disc-shaped shares using a single pump, a splitter is arranged to divide the hydraulic fluid. Consequently, as the efficiency of the hydraulic system depends, in part, on the largest load of either of the two shares, the overall efficiency of the hydraulic system is relatively low when the load of one share is considerably larger than the load of the other share due to, e.g., variation in soil content.

Mechanically coupling the rotational motion of the respective disc-shaped shares can ensure that the loads on the shares are jointly carried by the shares and, as a result, the efficiency of the hydraulic system can be enhanced. This enables the use of a motor with lower power in combination with the single pump.

Preferably, each disc-shaped share is directly connected to the hydraulic motor axle. Alternatively, the harvesting device further comprises a pair of transmissions, for instance gearboxes, respectively coupled to the pair of disc-shaped shares, wherein the pair of transmissions is configured to be coupled to a hydraulic drive and arranged for transferring power from the hydraulic drive to the respective disc-shaped shares to rotationally drive the pair of disc-shaped shares, wherein the coupling member is arranged to couple the transmissions.

To allow pivoting and tilting of the rotationally coupled disc-shaped shares, the coupling member preferably comprises at least one universal joint, homokinetic joint and/or sliding joint. For instance, the coupling member may be a Cardan shaft.

According to another aspect, a root crop harvester is provided, wherein the root crop harvester comprises a frame, wherein the root crop harvester is provided with a harvesting device according to any of the above embodiments, wherein the mounting frame of the harvesting device is mounted to the frame of the root crop harvester. The root crop harvester is movable in a travel direction for progressively harvesting root crop in soil along the travel direction. Preferably, the harvester further comprises a conveyor, wherein the harvesting device is arranged to deposit the collected root crop on the conveyor.

According to yet another aspect, a method of harvesting root crop, such as potato, in soil is provided, comprising the steps of:
providing a root crop harvester as described above;
moving the root crop harvester in a travel direction;
progressively harvesting root crop in soil along the travel direction by, using the at least one disc-shaped share, cutting into the soil and transporting root crop from said soil towards the processing region.

According to yet another aspect, a method of adapting a root crop harvester is provided, comprising the steps of:
providing the root crop harvester;
providing a harvesting device according to any of the above embodiments;
mounting the harvesting device on the root crop harvester.

The invention is hereafter further elucidated with reference to the attached drawings, wherein:

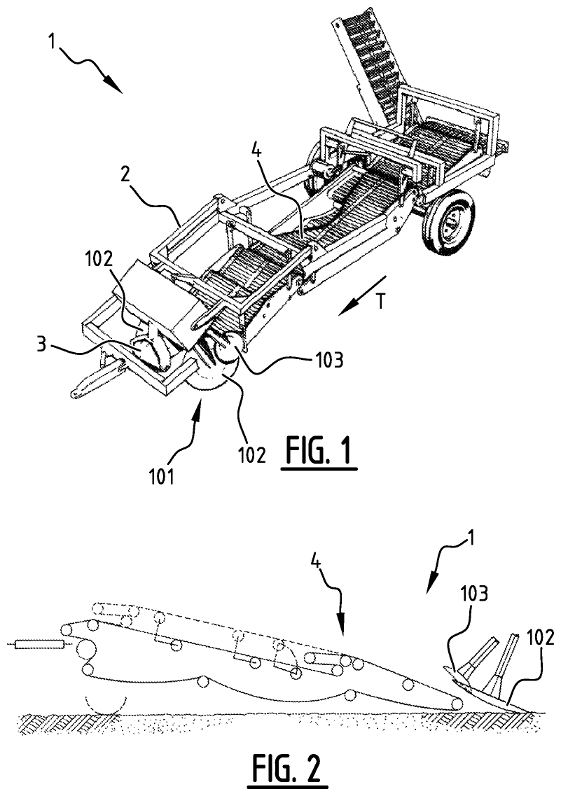

FIG. 1 shows a potato harvester;

FIG. 2 represents a schematic side view of the potato harvester;

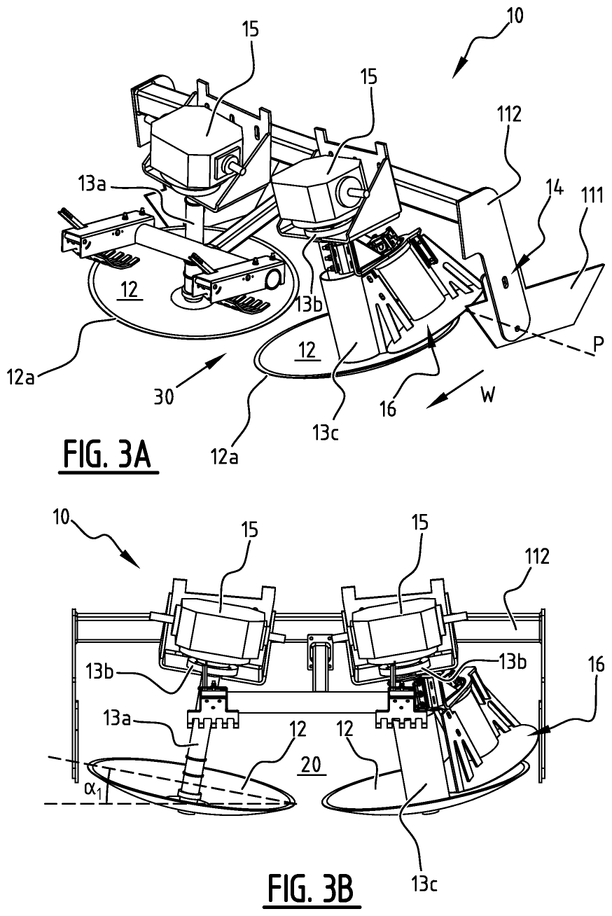

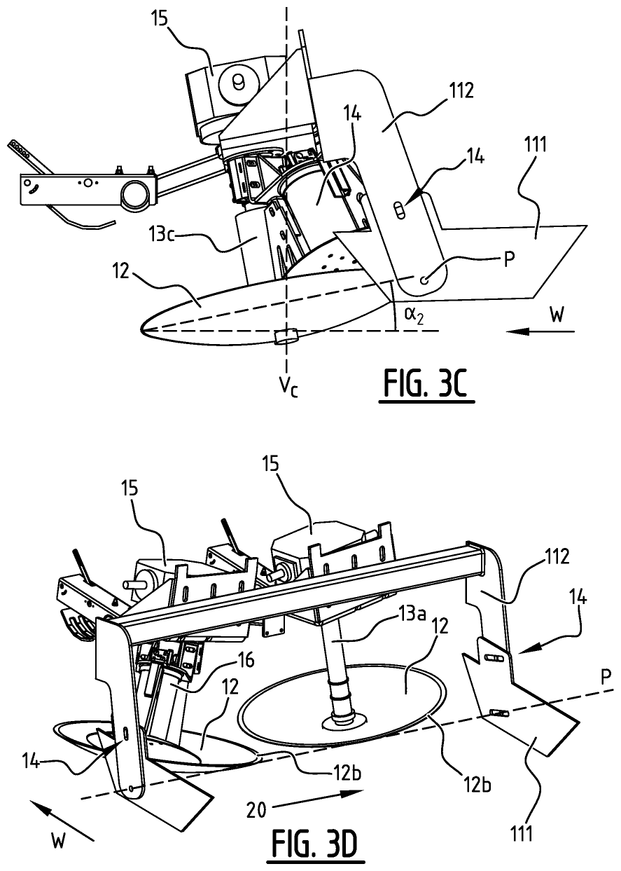

FIGS. 3A-D represent various views of a harvesting device;

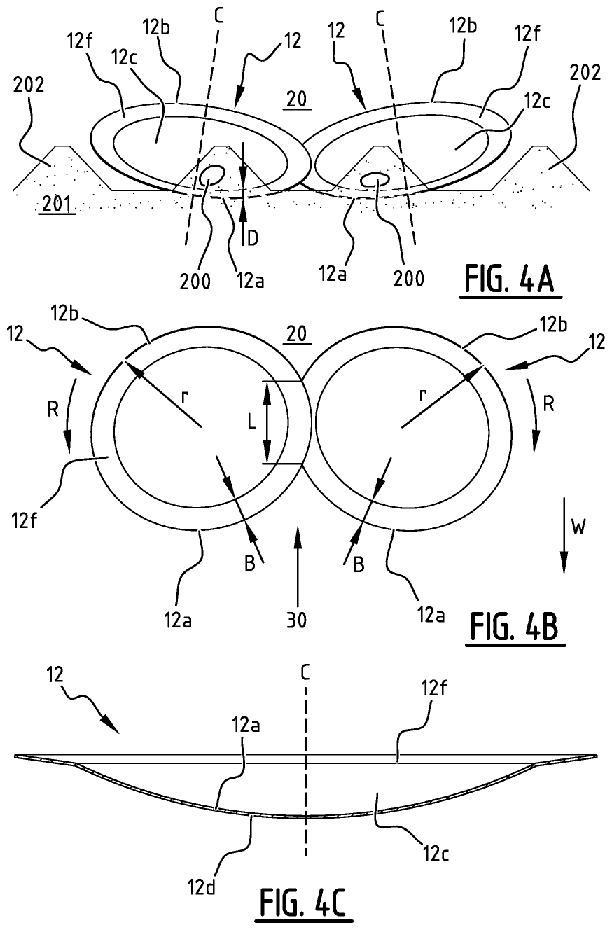

FIGS. 4A-B represent various views of a pair of dished disc-shaped shares;

FIG. 4C represents a cross-sectional view of a dished disc-shaped share;

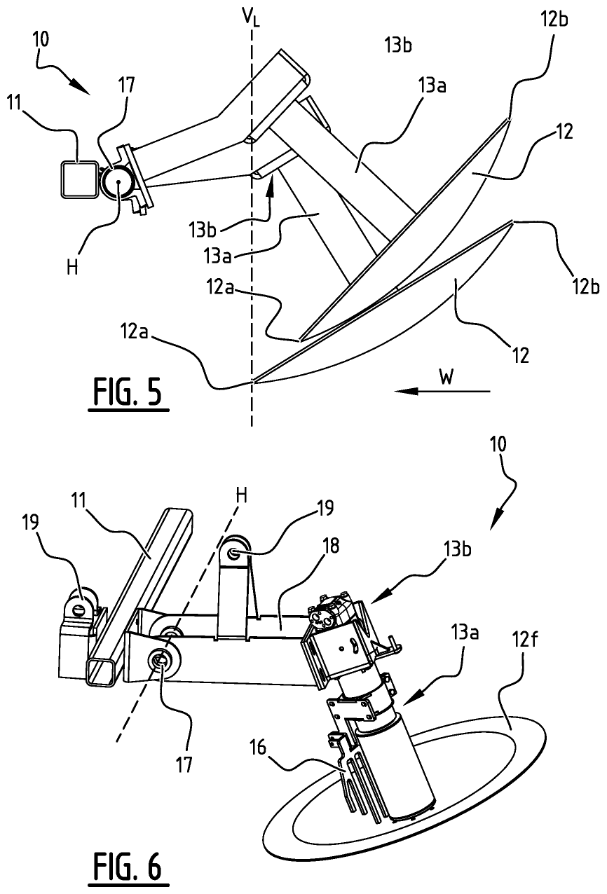

FIGS. 5-6 show variants of the harvesting device.

Throughout the drawings, like elements are indicated by like reference signs.

In FIG. 1 a potato harvester 1 is shown. The potato harvester 1 comprises a frame 2 and is provided with a known twin-disc share assembly 101 mounted to the frame 2 at the front of the harvester 1. The harvester 1 is movable in a travel direction T for progressively harvesting potatoes in soil along the travel direction T. A soil depth control roller 3, cone-shaped, is arranged ahead of the share assembly 101 for depth control.

The share assembly 101 has a pair of disc-shaped shares 102 for cutting into the soil ridges. The disc-shaped shares 102 are rotatably mounted side-by-side and are rotatable about their respective centre axes for collecting the potatoes, upon which the rotating disc-shaped shares 102 transport the potatoes through the region between the centres of the disc-shaped shares 102 towards the region where the root crops are to be deposited. The disc-shaped shares 102 can be selectively tilted relative to the ground. Each share 102 is provided with a power-driven rotatable scraper disc 103 arranged to overlap a portion of the share 102 and clean soil material from the share 102 by sweeping the soil material from the upper surface of the disc-shaped share 102.

The harvester 1 further comprises a conveyor 4. The harvester 1 harvests the potatoes by lifting the potatoes from the soil and onto the conveyor 4 using the shares 102. As the harvester 1 progresses, the harvester 1 draws the disc-shaped shares 102 along the ridges in which potatoes are growing. The shares 102 dig underneath the potatoes and the soil to progressively collect the soil material including the potatoes, which is moved on the shares 102 and transferred onto the conveyor 4, formed as a series of webs, schematically depicted from the side in FIG. 2. The conveyor 4 conveys the potatoes for further treatment on the harvester 1.

The harvester 1 can be advantageously adapted by disassembling the share assembly 101 from the frame 2 of the harvester 1 and mounting a harvesting device according to the invention on the harvester 1. FIGS. 3A-D show a harvesting device 10, wherein FIG. 3B represents a front view and FIG. 3C represents a lateral view. The harvesting device 10 is shown disassembled from the harvester 1 and configured to be mounted on the harvester 1 for progressively harvesting root crop in soil along a working direction W that corresponds to the travel direction T of the harvester 1.

The harvesting device 10 comprises a first mounting frame member 111 for mounting the harvesting device 10 on the frame 2 of the harvester 1, and a pair of dished disc-shaped shares 12 for cutting into the soil with leading edges 12a and for transporting potatoes from the soil towards a processing region 20. Each disc-shaped share 12 is mounted on a shaft 13a that extends coaxially from the concave surface of the dished share 12 and is rotatably supported by a bearing 13b.

The disc-shaped shares 12 are laterally tilted outwardly upwards relative to the horizontal at a lateral tilt angle α1 as seen in FIG. 3B. The pair of disc-shaped shares 12 is rotatably mounted to a second mounting frame member 112 pivotably connected to the first mounting frame member 111 about a horizontal pivot axis P that is parallel to a centre vertical plane V_{C} extending through a centre of the disc-shaped share. The pivot axis P extends, as seen along the working direction W, trailing the centre vertical plane V_{C} and below trailing edges 12b of the shares 12 (see FIGS. 3C and 3D). Specifically, the pivot axis P extends through the processing region 20. As such, each disc-shaped share 12 can be tilted rearwardly upwards at a rearward tilt angle α2 relative to the working direction W as seen from the side (FIG. 3C). Peg and slot adjusters 14 are arranged on either side of the pair of disc-shaped shares 12 for pivoting the second frame member 112 relative to the first mounting frame member 111 about the pivot axis P to adjust the rearward tilt angle α2 relative to the first mounting frame member 111, for instance for adaptation to a slope. By positioning the pivot axis P in the rear of the harvesting device 10, the rearward tilt angle α2 can be adjusted in a single adjustment step while ensuring that the pair of shares 12 can still deposit the collected potatoes onto the conveyor 4 of the harvester 1.

The harvester 1 comprises a hydraulic drive (not shown) for rotationally driving the pair of disc-shaped shares 12. The harvesting device 10 comprises a pair of gearboxes 15 coupled to the hydraulic drive and respectively coupled to the pair of disc-shaped shares 12 for transmitting torque from the hydraulic drive to the respective disc-shaped shares 12 to rotationally drive the pair of disc-shaped shares 12. The harvesting device 10 further comprises a Cardan shaft (not shown) arranged to couple the gearboxes 15 to couple the rotation of the disc-shaped shares 12.

Each share assembly is provided with additional components that, for illustration, are shown only for one of the shares. A cleaning member 16 is arranged to clean soil material from the share 12 by sweeping the soil material from the upper surface of the disc-shaped share 12. Furthermore, a cylindrical member 13c is arranged around the shaft 13a.

FIGS. 4A-C relate to specifics of the dished disc-shaped shares 12 of the harvesting device 10 for progressively harvesting potatoes 200 in soil 201 along a working direction W that corresponds to the travel direction T of the harvester 1. FIG. 4A represents a front view and FIG. 4B represents a top view. Each disc-shaped share 12 has a leading edge 12a, arranged to cut into a ridge 202 of the soil 201 pressed by the cone-shaped roller 3, and a trailing edge 12b opposite to the leading edge 12a. The disc-shaped shares 12 have equal radii r and rotate about their respective centre axes C in mutually opposite directions R to collect the potatoes 200 from the soil 201 in a transportation region 30 and transport the potatoes 200 towards the processing region 20. The centre axes C slope upwardly and inwardly.

Each dished disc-shaped share 12 comprises a dished centre 12c with a convex, preferably continuous, lower surface 12d and a flange 12f extending radially outwards from the dished centre 12c with an indicated breadth B. The upper surface 12e is concave and preferably continuous. As the disc-shaped share 12 is tilted rearwardly upwards, the flange 12f ensures a height difference D between the outermost region of the dished centre 12c and the leading edge 12a. This height difference D reduces the risk of the disc-shaped share 12 getting buried in the soil 201.

The flange 12f of the one disc-shaped share 12 overlaps the flange 12f of the other disc-shaped share 12 in the transportation region 30 over an indicated length L. As shown in the cross-sectional view in FIG. 4C, each flange 12f is frustoconical. This allows the flanges 12f of the laterally outwards tilted disc-shaped shares 12 to extend mutually parallel in the transportation region 30. As the disc-shaped shares 12 partially overlap, potatoes 200 falling off the one disc-shaped share 12 can be collected by the other disc-shaped share 12.

FIGS. 5 and 6 show different embodiments of a share protection mechanism of the harvesting device 10. Each disc-shaped share 12 is pivotably connected to a frame member 11 of the harvesting device 10 by a respective hinge 17. The hinge 17 is arranged for pivoting the disc-shaped share 12 about a horizontal hinge axis H from a cutting position, in which the disc-shaped share 12 is arranged to cut into the soil, upwards to a protected position, in which the disc-shaped share 12 is arranged out of the soil, upon collision of the disc-shaped share 12 with a rock in the soil. In FIG. 5, one disc-shaped share 12 can be seen in the cutting position while the other share is in the protected position. The hinge axis H is parallel to a leading vertical plane V_{L} tangent to the leading edge 12a of the disc-shaped share 12 in the cutting position. The leading vertical plane V_{L} is perpendicular to the working direction W. The hinge axis H extends above the leading edge 12a in the cutting position and is located, as seen along the working direction W, ahead of the leading vertical plane V_{L}. This ensures that the leading edge of the disc-shaped share moves directly upwards and rearwards, i.e., without first moving deeper into the soil.

In the embodiment shown in FIG. 5, each hinge 17 is a spring-loaded hinge arranged to bias the disc-shaped share 12 to the cutting position.

In FIG. 6, for the sake of simplicity, only one share 12 of the pair of disc-shaped shares is shown. The disc-shaped share is mounted on a shaft 13a that extends coaxially from the concave surface of the dished share 12 and that is rotatably supported by a bearing 13b supported by a support member 18 pivotably connected to the frame member 11 by the hinge 17. The support member 18 and the frame member 11 are provided with respective fastening means 19 and can be additionally connected to each other by an actuator (not shown) that is connected to the fastening means 19 and arranged to selectively pivot the disc-shaped share 12 about the hinge axis H between the cutting position and the protected position. The share assembly is furthermore provided with a stationary scraper 16 as cleaning member.

The figures and the above description serve to illustrate specific embodiments of the invention and do not limit the scope of protection defined by the appended claims.

The present disclosure includes the following embodiments:
1. Harvesting device configured to be mounted on a root crop harvester that is movable in a travel direction for progressively harvesting root crop in soil along the travel direction, wherein the harvesting device comprises a mounting frame for mounting the harvesting device on the root crop harvester, and a pair of dished disc-shaped shares for cutting into the soil and transporting root crop from said soil towards a processing region, wherein the disc-shaped shares are rotatably mounted side-by-side to the mounting frame, and the disc-shaped shares are rotatable about their respective centre axes in mutually opposite directions such that, during rotation, root crops are collected by the disc-shaped shares in a transportation region and moved towards the processing region, wherein an edge region of one of the disc-shaped shares overlaps an edge region of the other disc-shaped share in the transportation region.
2. Harvesting device according to embodiment 1, wherein at least one of the disc-shaped shares comprises a flange along its edge region, wherein the flange extends in the transportation region.
3. Harvesting device according to embodiment 2, wherein each of the disc-shaped shares comprises a flange along its respective edge region, wherein the flange of the one disc-shaped share overlaps the flange of the other disc-shaped share in the transportation region.
4. Harvesting device according to embodiment 3, wherein the flanges extend mutually parallel in the transportation region.
5. Harvesting device according to embodiment 2, 3 or 4, wherein each flange has a width of at least 10 percent of a radius of the disc-shaped shares.
6. Harvesting device according to any of the preceding embodiments, wherein the disc-shaped shares are laterally tilted outwardly upwards.
7. Harvesting device according to at least embodiments 4 and 6, wherein the flange lies in a frustoconical plane that is coaxial with the disc-shaped share.
8. Harvesting device according to any of the preceding embodiments, wherein the transportation region has an overlap length in the travel direction, wherein the overlap length is at least 50 percent of a radius of the disc-shaped shares.
9. Harvesting device according to any of the preceding embodiments, wherein the disc-shaped shares have corresponding radii.
10. Harvesting device according to any of the preceding embodiments, wherein each dished disc-shaped share has a convex lower surface and is tilted rearwardly upwards.
11. Harvesting device according to any of the preceding embodiments, wherein the harvesting device further comprises a share protection mechanism configured for displacing each disc-shaped share from a cutting position, in which the disc-shaped share is arranged to cut into the soil, upwards to a protected position, in which the disc-shaped share is arranged out of the soil, upon collision of the disc-shaped share with a hard object in the soil.
12. Harvesting device according to embodiment 11, wherein the share protection mechanism is configured for pivoting the disc-shaped share from the cutting position to the protected position about a hinge axis.
13. Harvesting device according to embodiment 12, wherein the hinge axis is parallel to a leading vertical plane tangent to a leading edge of the disc-shaped share in the cutting position, wherein the hinge axis extends above the leading edge in the cutting position and is located within or, as seen along the travel direction, ahead of said leading vertical plane.
14. Harvesting device according to embodiment 12 or 13, wherein the share protection mechanism comprises at least one hinge which pivotably connects the disc-shaped share to the mounting frame, wherein the hinge is arranged for pivoting the disc-shaped share from the cutting position to the protected position about the hinge axis.
15. Harvesting device according to any of the preceding embodiments 11-14, wherein the share protection mechanism comprises a biasing mechanism arranged to bias the disc-shaped shares to the cutting position.
16. Harvesting device according to at least embodiments 14 and 15, wherein the biasing mechanism comprises the hinge, wherein the hinge is a spring-loaded hinge.
17. Harvesting device according to any of the preceding embodiments 11-16, wherein the disc-shaped shares are separately movable from the cutting position to the protected position.
18. Harvesting device according to any of the preceding embodiments, wherein each disc-shaped share is tilted rearwardly upwards at a rearward tilt angle, wherein the harvesting device further comprises an adjustment mechanism for adjusting the rearward tilt angle relative to the frame, wherein the adjustment mechanism is configured for pivoting the pair of disc-shaped shares about a pivot axis parallel to a centre vertical plane extending through a centre of the disc-shaped share, wherein the pivot axis extends, as seen along the travel direction, trailing said centre vertical plane.
19. Harvesting device according to embodiment 18, wherein the pivot axis extends below a trailing edge of the at least one disc-shaped share.
20. Harvesting device according to embodiment 18 or 19, wherein the pivot axis extends through the processing region.
21. Harvesting device according to embodiment 18, 19 or 20, wherein the mounting frame comprises a first frame member and a second frame member, wherein the first frame member is configured to be mounted to the root crop harvester and the disc-shaped shares are mounted to the second frame member, wherein the second frame member is pivotably connected to the first frame member, wherein the adjustment mechanism is configured for pivoting the second frame member relative to the first frame member about the pivot axis.
22. Harvesting device according to embodiment 21, wherein the adjustment mechanism comprises a peg and slot adjuster provided in the first frame member and the second frame member.
23. Root crop harvester comprising a frame, wherein the root crop harvester is provided with a harvesting device according to any of the preceding embodiments, wherein the mounting frame of the harvesting device is mounted to the frame of the root crop harvester.
24. Method of harvesting root crop in soil, comprising the steps of:
   providing a root crop harvester according to embodiment 23;
   moving the root crop harvester in a travel direction;
   progressively harvesting root crop in soil along the travel direction by, using the pair of disc-shaped shares, cutting into the soil and transporting root crop from said soil towards the processing region.
25. Method of adapting a root crop harvester, comprising the steps of:
   providing the root crop harvester;
   providing a harvesting device according to any of the preceding embodiments 1-22;
   mounting the harvesting device on the root crop harvester.

1. A harvesting device configured to be mounted on a root crop harvester that is movable in a travel direction for progressively harvesting root crop in soil along the travel direction, wherein the harvesting device comprises a mounting frame for mounting the harvesting device on the root crop harvester, and a pair of dished disc-shaped shares for cutting into the soil and transporting root crop from said soil towards a processing region, wherein the disc-shaped shares are rotatably mounted side-by-side to the mounting frame, and the disc-shaped shares are rotatable about their respective centre axes in mutually opposite directions such that, during rotation, root crops are collected by the disc-shaped shares in a transportation region and moved towards the processing region, wherein the disc-shaped shares are laterally tilted outwardly upwards such that the centre axes slope upwardly and inwardly, characterised in that an edge region of one of the disc-shaped shares extends over an edge region of the other disc-shaped share in the transportation region in an overlapping manner and thereby covers part of the edge region of the other disc-shaped share when viewed from above.

2. The harvesting device according to claim 1, wherein at least one of the disc-shaped shares comprises a flange along its edge region, wherein the flange extends in the transportation region.

3. The harvesting device according to claim 2, wherein each of the disc-shaped shares comprises a flange along its respective edge region, wherein the flange of the one disc-shaped share overlaps the flange of the other disc-shaped share in the transportation region.

4. The harvesting device according to claim 3, wherein the flanges extend mutually parallel in the transportation region.

5. The harvesting device according to claim 2, wherein each flange has a width of at least 10 percent of a radius of the disc-shaped shares.

6. The harvesting device according to claim 1, wherein the disc-shaped shares are laterally tilted outwardly upwards relative to the horizontal at a lateral tilt angle of 20 degrees or less, preferably 15 degrees or less, more preferably 10 degrees or less.

7. The harvesting device according to claim 4, wherein the flange lies in a frustoconical plane that is coaxial with the disc-shaped share.

8. The harvesting device according to claim 1, wherein the transportation region has an overlap length in the travel direction, wherein the overlap length is at least 50 percent of a radius of the disc-shaped shares.

9. The harvesting device according to claim 1, wherein the disc-shaped shares have corresponding radii.

10. The harvesting device according to claim 1, wherein each dished disc-shaped share has a convex lower surface and is tilted rearwardly upwards.

11. The harvesting device according to claim 1, wherein the harvesting device further comprises a share protection mechanism configured for displacing each disc-shaped share from a cutting position, in which the disc-shaped share is arranged to cut into the soil, upwards to a protected position, in which the disc-shaped share is arranged out of the soil, upon collision of the disc-shaped share with a hard object in the soil.

12. The harvesting device according to claim 11, wherein the share protection mechanism is configured for pivoting the disc-shaped share from the cutting position to the protected position about a hinge axis.

13. The harvesting device according to claim 12, wherein the hinge axis is parallel to a leading vertical plane tangent to a leading edge of the disc-shaped share in the cutting position, wherein the hinge axis extends above the leading edge in the cutting position and is located within or, as seen along the travel direction, ahead of said leading vertical plane.

14. The harvesting device according to claim 12, wherein the share protection mechanism comprises at least one hinge which pivotably connects the disc-shaped share to the mounting frame, wherein the hinge is arranged for pivoting the disc-shaped share from the cutting position to the protected position about the hinge axis.

15. The harvesting device according to claim 11, wherein the share protection mechanism comprises a biasing mechanism arranged to bias the disc-shaped shares to the cutting position.

16. The harvesting device according to claim 14, wherein the biasing mechanism comprises the hinge, wherein the hinge is a spring-loaded hinge.

17. The harvesting device according to claim 11, wherein the disc-shaped shares are separately movable from the cutting position to the protected position.

18. The harvesting device according to claim 1, wherein each disc-shaped share is tilted rearwardly upwards at a rearward tilt angle, wherein the harvesting device further comprises an adjustment mechanism for adjusting the rearward tilt angle relative to the frame, wherein the adjustment mechanism is configured for pivoting the pair of disc-shaped shares about a pivot axis parallel to a centre vertical plane extending through a centre of the disc-shaped share, wherein the pivot axis extends, as seen along the travel direction, trailing said centre vertical plane.

19. The harvesting device according to claim 18, wherein the pivot axis extends below a trailing edge of the at least one disc-shaped share.

20. The harvesting device according to claim 18, wherein the pivot axis extends through the processing region.

21. The harvesting device according to claim 18, wherein the mounting frame comprises a first frame member and a second frame member, wherein the first frame member is configured to be mounted to the root crop harvester and the disc-shaped shares are mounted to the second frame member, wherein the second frame member is pivotably connected to the first frame member, wherein the adjustment mechanism is configured for pivoting the second frame member relative to the first frame member about the pivot axis.

22. The harvesting device according to claim 21, wherein the adjustment mechanism comprises a peg and slot adjuster provided in the first frame member and the second frame member.

23. (canceled)

24. (canceled)

25. (canceled)
